(19) United States
(12) Patent Application Publication
(10) Pub. No.: US 2008/0273486 A1
(43) Pub. Date: Nov. 6, 2008

(54) Wireless Protocol Adapter

(75) Inventors: Wallace A. Pratt, Pflugerville, TX (US); Mark J. Nixon, Round Rock, TX (US); Eric D. Rotvold, West St. Paul, MN (US); Robin S. Pramanik, Karlsruhe (DE); Tomas P. Lennvall, Vasteras (SE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HART COMMUNICATION FOUNDATION

(21) Appl. No.: 12/101,000

(22) Filed: Apr. 10, 2008

Related U.S. Application Data
(60) Provisional application No. 60/911,795, filed on Apr. 13, 2007.

(51) Int. Cl. H04Q 7/00

(52) U.S. Cl. 370/328

(57) ABSTRACT

A wireless protocol adapter for use in a process system includes a wireless interface that communicates with a multi-node wireless communication network using a wireless communication protocol, a wired interface that connects to a first field device over a wired link, and a processing unit that transfers process data between the wireless communication network and the first field device to enable operation of the first field device and of the wireless protocol adapter in the wireless communication network as distinct network nodes.

### CROSS-REFERENCE TO RELATED APPLICATIONS

This application is based on and claims the benefit of priority to U.S. Provisional Application No. 60/911,795, entitled “Routing, Scheduling, Reliable and Secure Operations in a Wireless Communication Protocol” filed Apr. 13, 2007 (attorney docket no. 31244/42509P), the entire disclosure of which is hereby expressly incorporated herein by reference.

### FIELD OF TECHNOLOGY

The present invention relates generally to wireless communications in a process control environment and, more particularly, to a wireless protocol adapter providing wireless functionality to a wired field device.

### BACKGROUND

In the process control industry, it is known to use standardized communication protocols to enable devices made by different manufacturers to communicate with one another in an easy to use and implement manner. One such well known communication standard used in the process control industry is the Highway Addressable Remote Transmitter (HART) Communication Foundation protocol, referred to generally as the HART® protocol. Generally speaking, the HART® protocol supports a combined digital and analog signal on a dedicated wire or set of wires, in which on-line process signals (such as control signals, sensor measurements, etc.) are provided as an analog current signal (e.g., ranging from 4 to 20 milliamps) and in which other signals, such as device data, requests for device data, configuration data, alarm and event data, etc., are provided as digital signals superimposed or multiplexed onto the same wire or set of wires as the analog signal. However, the HART protocol currently requires the use of dedicated, hardwired communication lines, resulting in significant wiring needs within a process plant.

There has been a move, in the past number of years, to incorporate wireless technology into various industries including, in some limited manners, the process control industry. However, there are significant hurdles in the process control industry that limit the full scale incorporation, acceptance and use of wireless technology. In particular, the process control industry requires a completely reliable process control network because loss of signals can result in the loss of control of a plant, leading to catastrophic consequences, including explosions, the release of deadly chemicals or gases, etc. For example, Tapperson et al., U.S. Pat. No. 6,236,334 discloses the use of a wireless communications in the process control industry as a secondary or backup communication path or for use in sending non-critical or redundant communication signals. Moreover, there have been many advances in the use of wireless communication systems in general that may be applicable to the process control industry, but which have not yet been applied to the process control industry in a manner that allows or provides a reliable, and in some instances completely wireless, communication network within a process plant. U.S. Patent Application Publication Numbers 2005/0213612, 2006/0029060 and 2006/0029061 for example disclose various aspects of wireless communication technology related to a general wireless communication system.

Similar to wired communications, wireless communication protocols are expected to provide efficient, reliable and secure methods of exchanging information. Of course, much of the methodology developed to address these concerns on wired networks does not apply to wireless communications because of the shared and open nature of the medium. Further, in addition to the typical objectives behind a wired communication protocol, wireless protocols face other requirements with respect to the issues of interference and co-existence of several networks that use the same part of the radio frequency spectrum. Moreover, some wireless networks operate in the part of the spectrum that is unlicensed, or open to the public. Therefore, protocols servicing such networks must be capable of detecting and resolving issues related to frequency (channel) contention, radio resource sharing and negotiation, etc.

In the process control industry, developers of wireless communication protocols face additional challenges, such as achieving backward compatibility with wired devices, supporting previous wired versions of a protocol, providing transition services to devices retrofitted with wireless communicators, and providing routing techniques which can ensure both reliability and efficiency. Meanwhile, there remains a wide number of process control applications in which there are few, if any, in-place measurements. Currently these applications rely on observed measurements (e.g. water level is rising) or inspection (e.g. period maintenance of air conditioning unit, pump, fan, etc) to discover abnormal situations. In order to take action, operators frequently require face-to-face discussions. Many of these applications could be greatly simplified if measurement and control devices were utilized. However, current measurement devices usually require power, communications infrastructure, configuration, and support infrastructure which simply is not available.

### SUMMARY

A wireless protocol adapter for use in a process control industry includes a wireless interface for communicating with at least one wireless device and a wired interface for communicating with at least one wired device. In at least some of the embodiments, the wireless protocol adapter connects via the wireless interface to a multi-node wireless mesh network which may include wireless field devices. The wireless protocol adapter may provide discovery, registration, protocol translation, and other functionality to enable each wired device connected to the adapter via the wired protocol to seamlessly join the wireless mesh network. In one such embodiment, the wireless protocol adapter operates as one of the network nodes in the multi-node mesh network and acquires a unique network address. In some embodiments, the wired interface of the wireless protocol adapter supports multiple wired devices and, in this sense, the wireless protocol adapter may additionally function as a hub. Additionally, the wireless protocol adapter may operate as a protocol bridge by providing command translation and/or data conversion between the wireless network and the one or more wired devices.

In some embodiments, the wireless network may support a wireless extension of the HART® communication protocol by sharing at least the application layer of the protocol stack with the existing wired HART® communication protocol. The wireless protocol adapter may provide bidirectional translation between wired and wireless HART protocols by separating the shared application layer from the lower layers and by tunneling HART commands between the wired and wireless interfaces. In one such embodiment, the wireless protocol adapter is assigned a HART Device Descriptor (DD) and may also conform to the Device Description Language (DLL) format. In some cases, the one or more wired devices connected to the wireless protocol adapter are smart field devices supporting the HART® communication protocol. In other cases, the one or more field devices may be analog 4-20 mA legacy field devices; and the wireless protocol adapter may function both as a HART modem and as a bridge between the legacy devices and the wireless network. Moreover, in some of these embodiments, the wireless network adapter may be powered by the current in the control loop including the one or more legacy devices. Optionally, the wireless network adapter may include a power scavenging circuit for obtaining the necessary power in a minimally intrusive manner.

In these or other embodiments, the wireless protocol adapter may additionally support such wired communication standards as Foundation Fieldbus H1 protocol, Profibus, DeviceNet, etc. Additionally, the wired interface of the wireless protocol adapter may support a handheld device for monitoring or maintenance applications. In some further embodiments, a wireless protocol adapter may have multiple wired interfaces for supporting several types of devices.

In one particular embodiment, the wired interface of the wireless protocol adapter may support one or more wired HART device, each having an address consistent with the addressing scheme of the HART Communication Foundation (HCF). In the embodiments of the wireless mesh network relying on a wireless extension of the HART protocol, a network device operating in the wireless HART network may address each of the wired HART devices by using the HART address of the wired device and routing the corresponding data via the wireless protocol adapter. In this sense, each of the wired protocol adapter and the one or wired devices connected to the adapter via the wired interface may be viewed as separate nodes of the wireless HART network. In at least some of the embodiments, the wireless protocol adapter supporting the HART protocol provides at least the functionality of a HART multiplexer.

### DETAILED DESCRIPTION OF THE DRAWINGS

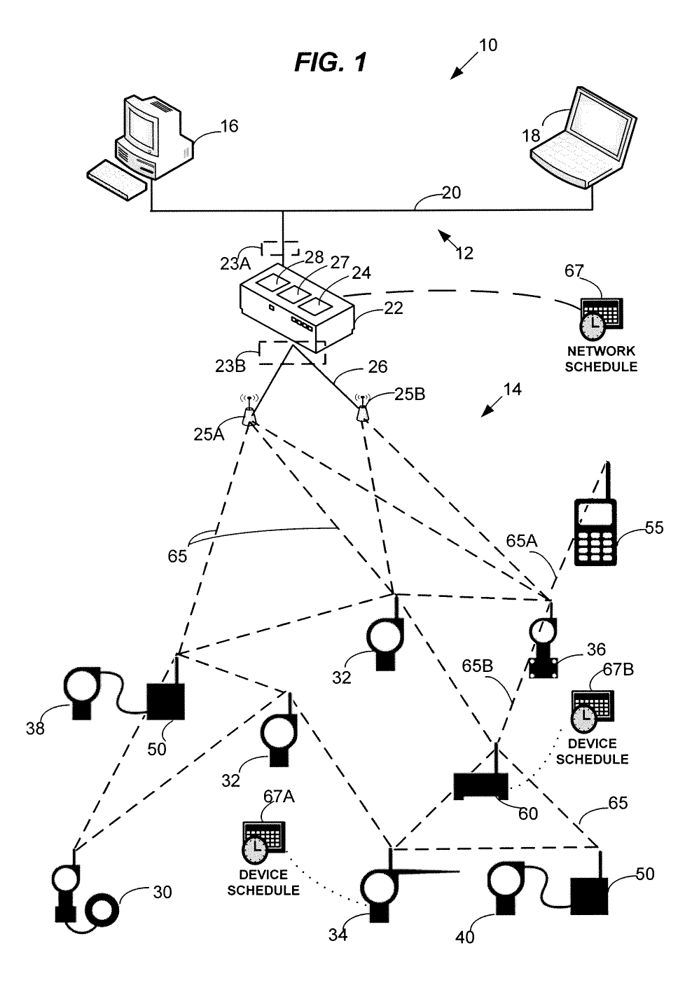

FIG. 1 schematically illustrates a wireless network in which a wireless protocol adapter of the present disclosure may operate.

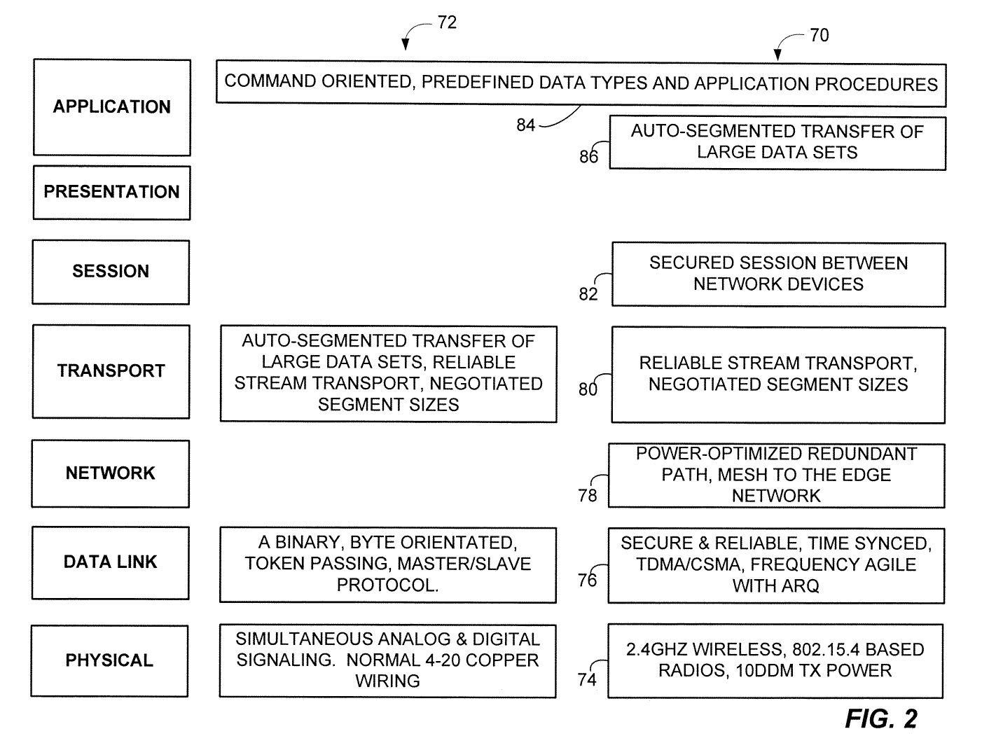

FIG. 2 is a schematic representation of the layers of a wireless HART protocol which may be used in the wireless network illustrated in FIG. 1.

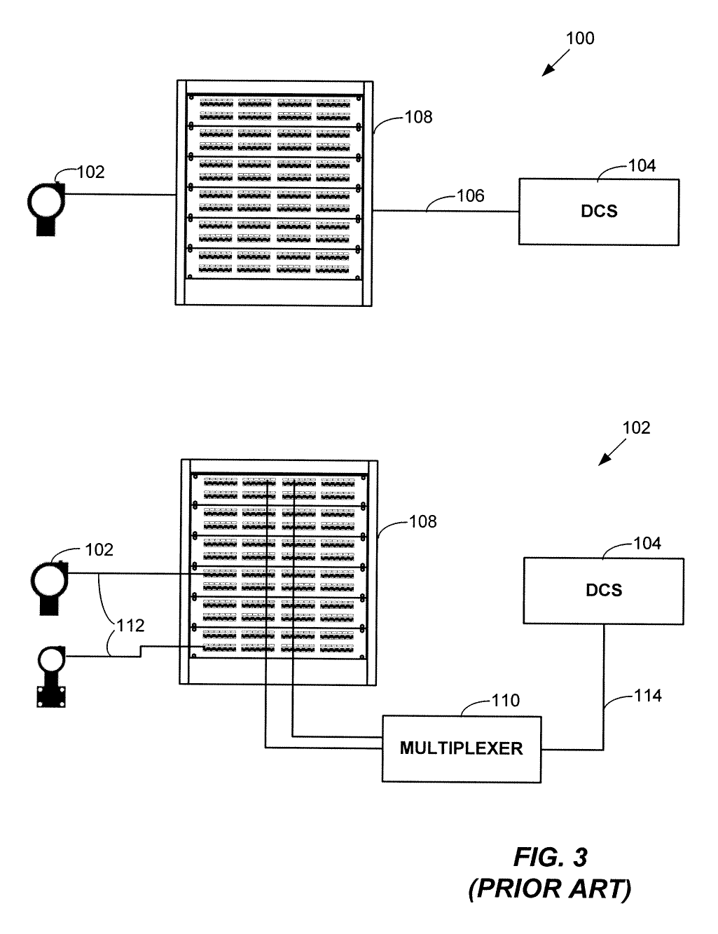

FIG. 3 is a block diagram illustrating the use of a prior art multiplexer to support HART communications with a legacy field device.

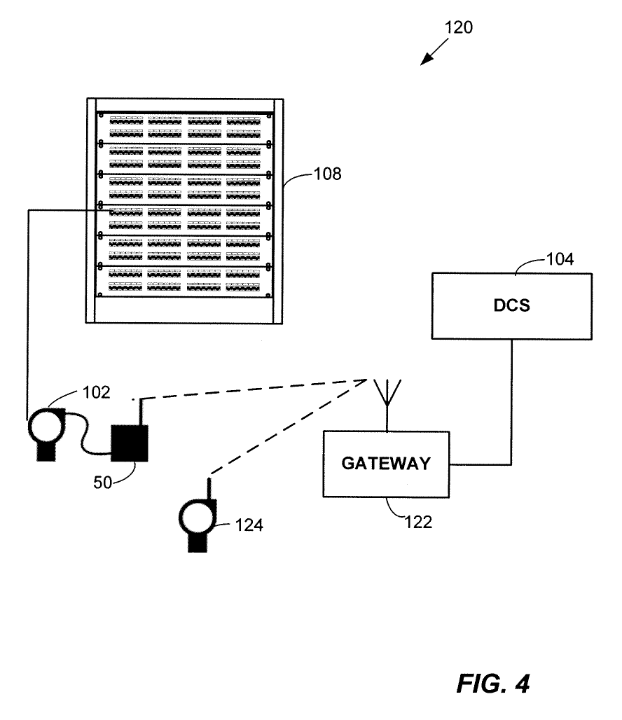

FIG. 4 is a block diagram illustrating the use of a wireless protocol adapter for supporting wireless HART communications with the legacy field device illustrated in FIG. 2.

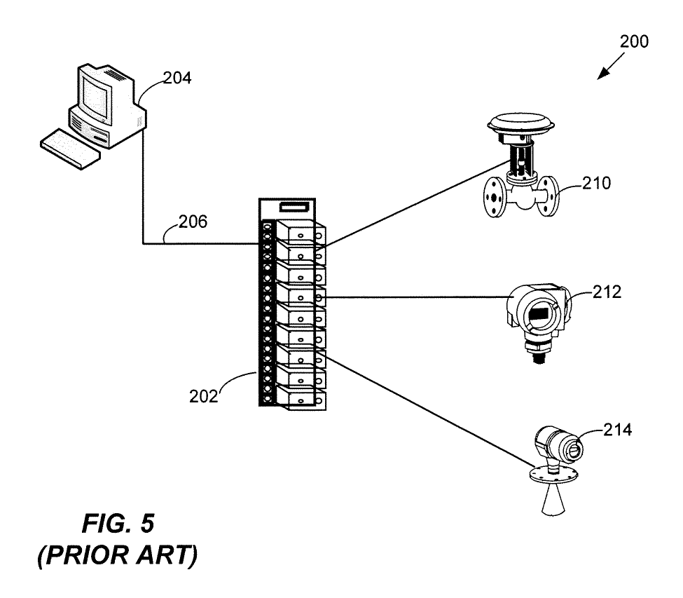

FIG. 5 illustrates a prior art system in which a remote I/O module supports several wired HART devices.

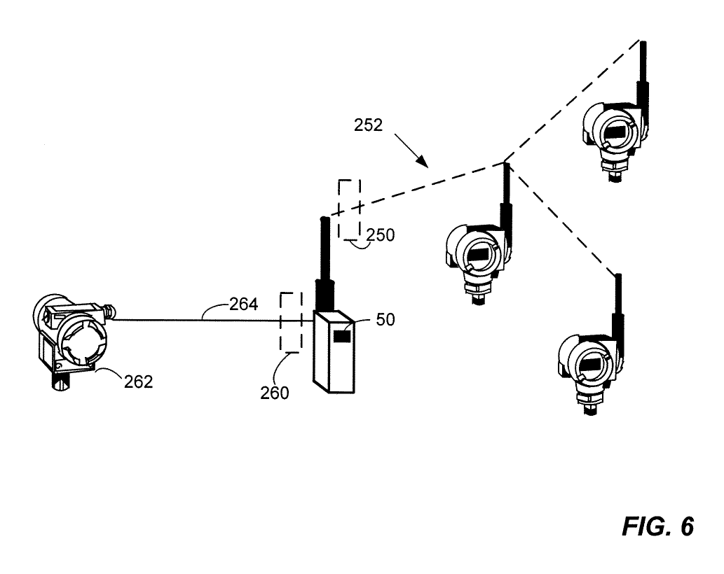

FIG. 6 illustrates a wireless protocol adapter of the present disclosure connected to a wired field device and a wireless communication network.

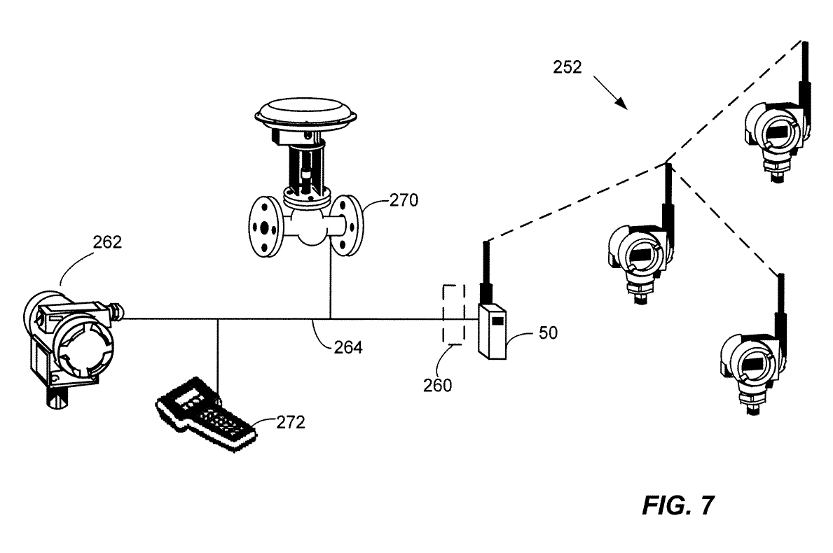

FIG. 7 illustrates another configuration in which a wireless protocol adapter of the present disclosure is connected to multiple wired field devices, a wired handheld device, and a wireless communication network.

### DETAILED DESCRIPTION

FIG. 1 illustrates an exemplary network 10 in which a wireless protocol adapter described herein may be used. In particular, the network 10 may include a plant automation network 12 connected to a wireless communication network 14. The plant automation network 12 may include one or more stationary workstations 16 and one or more portable workstations 18 connected over a communication backbone 20 which may be implemented using Ethernet, RS-485, Profibus DP, or using other suitable communication hardware and protocol. The workstations and other equipment forming the plant automation network 12 may provide various control and supervisory functions to plant personnel, including access to devices in the wireless network 14. The plant automation network 12 and the wireless network 14 may be connected via a wireless gateway 22. More specifically, the wireless gateway 22 may be connected to the backbone 20 in a wired or wireless (e.g. 802.11g) manner via a first (or “host”) interface 23A and may communicate with the plant automation network 12 using any suitable (e.g., known) communication protocol. The second (or “wireless”) interface 23B of the wireless gateway 22 may support wireless communications with one or several devices operating in the wireless network 14.

In operation, the wireless gateway 22, which may be implemented in any other desired manner (e.g., as a standalone device, a card insertable into an expansion slot of the workstations 16 or 18, as a part of the input/output (IO) subsystem of a PLC-based or DCS-based system, etc.), may provide applications that are running on the plant automation network 12 with access to various devices of the wireless network 14. In some embodiments, the protocols servicing the networks 12 and 14 may share one or more upper layers of the respective protocol stacks, and the wireless gateway 22 may provide the routing, buffering, and timing services to the lower layers of the protocol stacks (e.g., address conversion, routing, packet segmentation, prioritization, etc.) while tunneling the shared layer or layers of the protocol stacks. In other cases, the wireless gateway 22 may translate commands between the protocols of the networks 12 and 14 which do not share any protocol layers.

In addition to protocol and command conversion, the wireless gateway 22 may provide synchronized clocking used by time slots and superframes (sets of communication time slots spaced equally in time) of a scheduling scheme associated with a wireless protocol (referred to herein as a WirelessHART protocol) implemented in the wireless network 14. In particular, the wireless gateway 22 may propagate synchronization data through the wireless network 14 at predetermined intervals.

In some configurations, the network 10 may include more than one wireless gateway 22 to improve the efficiency and reliability of the network 10. In particular, multiple gateway devices 22 may provide additional bandwidth for the communication between the wireless network 14 and the plant automation network 12, as well as the outside world. On the other hand, the gateway 22 device may request bandwidth from the appropriate network service according to the gateway communication needs within the wireless network 14. A network manager software module 27, which may reside in the wireless gateway 22, may further reassess the necessary bandwidth while the system is operational. For example, the wireless gateway 22 may receive a request from a host residing outside of the wireless network 14 to retrieve a large amount of data. The wireless gateway 22 may then request the network manager 27 to allocate additional bandwidth to accommodate this transaction. For example, the wireless gateway 22 may issue an appropriate service request. The wireless gateway 22 may then request the network manager 27 to release the bandwidth upon completion of the transaction.

With continued reference to FIG. 1, the wireless network 14 may include one or more field devices 30-36. In general, process control systems, like those used in chemical, petroleum or other process plants, include field devices such as valves, valve positioners, switches, sensors (e.g., temperature, pressure and flow rate sensors), pumps, fans, etc. Generally speaking, field devices perform physical control functions within the process such as opening or closing valves or take measurements of process parameters. In the wireless communication network 14, field devices 30-36 are producers and consumers of wireless communication packets.

The devices 30-36 may communicate using a wireless communication protocol that provides the functionality of a similar wired network, with similar or improved operational performance. In particular, this protocol may enable the system to perform process data monitoring, critical data monitoring (with the more stringent performance requirements), calibration, device status and diagnostic monitoring, field device troubleshooting, commissioning, and supervisory process control. The applications performing these functions, however, typically require that the protocol supported by the wireless network 14 provide fast updates when necessary, move large amounts of data when required, and support network devices which join the wireless network 14, even if only temporarily for commissioning and maintenance work.

If desired, the wireless network 14 may include non-wireless devices. For example, a field device 38 of FIG. 1 may be a legacy 4-20 mA device and a field device 40 may be a traditional wired HART device. To communicate within the wireless network 14, the field devices 38 and 40 may be connected to the wireless network 14 via a wireless protocol adapter 50 or 50A. In those embodiments of the wireless network 14 which use HART protocol, the wireless protocol adapter 50 or 50A may accordingly support the wireless extension of the HART protocol and may be referred to as a WirelessHART adapter (WHA). Additionally, the wireless protocol adapter 50 may support other communication protocols such as Foundation® Fieldbus, PROFIBUS, DeviceNet, etc. In these embodiments, the wireless protocol adapter 50 supports protocol translation on a lower layer of the protocol stack. Additionally, it is contemplated that a single wireless protocol adapter 50 may also function as a multiplexer and may support multiple HART or non-HART devices.

In general, the network manager 27 may be responsible for adapting the wireless network 14 to changing conditions and for scheduling communication resources. As network devices join and leave the network, the network manager 27 may update its internal model of the wireless network 14 and use this information to generate communication schedules and communication routes. Additionally, the network manager 27 may consider the overall performance of the wireless network 14 as well as the diagnostic information to adapt the wireless network 14 to changes in topology and communication requirements. Once the network manager 27 has generated the overall communication schedule, all or respective parts of the overall communication schedule may be transferred through a series of commands from the network manager 27 to the network devices.

To further increase bandwidth and improve reliability, the wireless gateway 22 may be functionally divided into a virtual gateway 24 and one or more network access points 25, which may be separate physical devices in wired communication with the wireless gateway 22. However, while FIG. 1 illustrates a wired connection 26 between the physically separate wireless gateway 22 and the access points 25, it will be understood that the elements 22-26 may also be provided as an integral device. Because the network access points 25 may be physically separated from the wireless gateway 22, the access points 25 may be strategically placed in several different locations with respect to the wireless network 14. In addition to increasing the bandwidth, multiple access points 25 can increase the overall reliability of the wireless network 14 by compensating for a potentially poor signal quality at one access point 25 using the other access point 25. Having multiple access points 25 also provides redundancy in case of a failure at one or more of the access points 25.

In addition to allocating bandwidth and otherwise bridging the networks 12 and 14, the wireless gateway 22 may perform one or more managerial functions in the wireless network 14. As illustrated in FIG. 1, a network manager software module 27 and a security manager software module 28 may be stored in and executed in the wireless gateway 22. Alternatively, the network manager 27 and/or the security manager 28 may run on one of the workstations 16 or 18 in the plant automation network 12. For example, the network manager 27 may run on the host 16 and the security manager 28 may run on the host 18. The network manager 27 may be responsible for configuration of the wireless network 14, scheduling communication between wireless devices, managing routing tables associated with the wireless devices, monitoring the overall health of the wireless network 14, reporting the health of the wireless network 14 to the workstations 16 and 18, as well as other administrative and supervisory functions. Although a single active network manager 27 may be sufficient in the wireless network 14, redundant network managers 27 may be similarly supported to safeguard the wireless network 14 against unexpected equipment failures. Meanwhile, the security manager 28 may be responsible for protecting the wireless network 14 from malicious or accidental intrusions by unauthorized devices. To this end, the security manager 28 may manage authentication codes, verify authorization information supplied by devices attempting to join the wireless network 14, update temporary security data such as expiring secret keys, and perform other security functions.

With continued reference to FIG. 1, the wireless network 14 may include one or more field devices 30-36. In general, process control systems, like those used in chemical, petroleum or other process plants, include such field devices as valves, valve positioners, switches, sensors (e.g., temperature, pressure and flow rate sensors), pumps, fans, etc. Field devices perform physical control functions within the process such as opening or closing valves or take measurements of process parameters. In the wireless communication network 14, field devices 30-36 are producers and consumers of wireless communication packets.

The devices 30-36 may communicate using a wireless communication protocol that provides the functionality of a similar wired network, with similar or improved operational performance. In particular, this protocol may enable the system to perform process data monitoring, critical data monitoring (with the more stringent performance requirements), calibration, device status and diagnostic monitoring, field device troubleshooting, commissioning, and supervisory process control. The applications performing these functions, however, typically require that the protocol supported by the wireless network 14 provide fast updates when necessary, move large amounts of data when required, and support network devices which join the wireless network 14, even if only temporarily for commissioning and maintenance work.

In one embodiment, the wireless protocol supporting network devices 30-36 of the wireless network 14 is an extension of the known wired HART protocol, a widely accepted industry standard, that maintains the simple workflow and practices of the wired environment. In this sense, the network devices 30-36 may be considered WirelessHART devices. The same tools used for wired HART devices may be easily adapted to wireless devices 30-36 with a simple addition of new device description files. In this manner, the wireless protocol may leverage the experience and knowledge gained using the wired HART protocol to minimize training and simplify maintenance and support. Generally speaking, it may be convenient to adapt a protocol for wireless use so that most applications running on a device do not “notice” the transition from a wired network to a wireless network. Clearly, such transparency greatly reduces the cost of upgrading networks and, more generally, reduces the cost associated with developing and supporting devices that may be used with such networks. Some of the additional benefits of a wireless extension of the well-known HART protocol include access to measurements that were difficult or expensive to obtain with wired devices and the ability to configure and operate instruments from system software that can be installed on laptops, handhelds, workstations, etc. Another benefit is the ability to send diagnostic alerts from wireless devices back through the communication infrastructure to a centrally located diagnostic center. For example, every heat exchanger in a process plant could be fitted with a WirelessHART device and the end user and supplier could be alerted when a heat exchanger detects a problem. Yet another benefit is the ability to monitor conditions that present serious health and safety problems. For example, a WirelessHART device could be placed in flood zones on roads and be used to alert authorities and drivers about water levels. Other benefits include access to a wide range of diagnostics alerts and the ability to store trended as well as calculated values at the WirelessHART devices so that, when communications to the device are established, the values can be transferred to a host. In this manner, the WirelessHART protocol can provide a platform that enables host applications to have wireless access to existing HART-enabled field devices and the WirelessHART protocol can support the deployment of battery operated, wireless only HART-enabled field devices. The WirelessHART protocol may be used to establish a wireless communication standard for process applications and may further extend the application of HART communications and the benefits that this protocol provides to the process control industry by enhancing the basic HART technology to support wireless process automation applications.

Referring again to FIG. 1, the field devices 30-36 may be WirelessHART field devices, each provided as an integral unit and supporting all layers of the WirelessHART protocol stack. For example, in the wireless network 14, the field device 30 may be a WirelessHART flow meter, the field devices 32 may be WirelessHART pressure sensors, the field device 34 may be a WirelessHART valve positioner, and the field device 36 may be a WirelessHART pressure sensor. Importantly, the wireless devices 30-36 may support all of the HART features that users have come to expect from the wired HART protocol. As one of ordinary skill in the art will appreciate, one of the core strengths of the HART protocol is its rigorous interoperability requirements. In some embodiments, all WirelessHART equipment includes core mandatory capabilities in order to allow equivalent device types (made by different manufacturers, for example) to be interchanged without compromising system operation. Furthermore, the WirelessHART protocol is backward compatible to HART core technology such as the device description language (DDL). In the preferred embodiment, all of the WirelessHART devices should support the DDL, which ensures that end users immediately have the tools to begin utilizing the WirelessHART protocol.

If desired, the wireless network 14 may include non-wireless devices. For example, a field device 38 of FIG. 1 may be a legacy 4-20 mA device and a field device 40 may be a traditional wired HART device. To communicate within the network 14, the field devices 38 and 40 may be connected to the wireless network 14 via a WirelessHART adapter (WHA) 50. In this case, the wireless network 14 may be considered a WirelessHART network. Additionally, the wireless protocol adapter 50 may support other communication protocols such as FOUNDATION® Fieldbus, PROFIBUS, DeviceNet, etc. In these embodiments, the wireless protocol adapter 50 supports protocol translation on a lower layer of the protocol stack. Additionally, it is contemplated that a single wireless protocol adapter 50 may also function as a multiplexer and may support multiple HART or non-HART devices.

Plant personnel may additionally use handheld devices for installation, control, monitoring, and maintenance of network devices. Generally speaking, handheld devices are portable equipment that can connect directly to the wireless network 14 or through the gateways 22 as a host on the plant automation network 12. As illustrated in FIG. 1, a WirelessHART-connected handheld device 55 may communicate directly with the wireless network 14. When operating with a formed wireless network 14, the handheld device 55 may join the network 14 as just another WirelessHART field device. When operating with a target network device that is not connected to a WirelessHART network, the handheld device 55 may operate as a combination of the wireless gateway 22 and the network manager 27 by forming its own wireless network with the target network device.

A plant automation network-connected handheld device (not shown) may be used to connect to the plant automation network 12 through known networking technology, such as Wi-Fi. This device communicates with the network devices 30-40 through the wireless gateway 22 in the same fashion as external plant automation servers (not shown) or the workstations 16 and 18 communicate with the devices 30-40.

Additionally, the wireless network 14 may include a router device 60 which is a network device that forwards packets from one network device to another network device. A network device that is acting as a router device uses internal routing tables to conduct routing, i.e., to decide to which network device a particular packet should be sent. Standalone routers such as the router 60 may not be required in those embodiments where all of the devices on the wireless network 14 support routing. However, it may be beneficial (e.g. to extend the network, or to save the power of a field device in the network) to add one or more dedicated routers 60 to the network 14.

All of the devices directly connected to the wireless network 14 may be referred to as network devices. In particular, the wireless field devices 30-36, the wireless protocol adapters 50, the routers 60, the gateway devices 22, the access points 25, and the wireless handheld device 55 are, for the purposes of routing and scheduling, network devices, each of which forms a node of the wireless network 14. In order to provide a very robust and an easily expandable wireless network, all of the devices in a network may support routing and each network device may be globally identified by a substantially unique address, such as a HART address, for example. The network manager 27 may contain a complete list of network devices and may assign each device a short, network unique 16-bit (for example) nickname. Additionally, each network device may store information related to update (or “scan”) rates, connection sessions, and device resources. In short, each network device maintains up-to-date information related to routing and scheduling within the wireless network 14. The network manager 27 may communicate this information to network devices whenever new devices join the network or whenever the network manager 27 detects or originates a change in topology or scheduling of the wireless network 14.

Further, each network device may store and maintain a list of neighbor devices that the network device has identified during listening operations. Generally speaking, a neighbor of a network device is another network device of any type potentially capable of establishing a connection with the network device in accordance with the standards imposed by a corresponding network. In case of the WirelessHART network 14, the connection is a direct wireless connection. However, it will be appreciated that a neighboring device may also be a network device connected to the particular device in a wired manner. As will be discussed later, network devices may promote their discovery by other network devices through advertisement, or special messages sent out during designated periods of time. Network devices operatively connected to the wireless network 14 have one or more neighbors which they may choose according to the strength of the advertising signal or to some other principle.

In the example illustrated in FIG. 1, each of a pair of network devices connected by a direct wireless connection 65 recognizes the other as a neighbor. Thus, network devices of the wireless network 14 may form a large number of inter-device connections 65. The possibility and desirability of establishing a direct wireless connection 65 between two network devices is determined by several factors, such as the physical distance between the nodes, obstacles between the nodes (devices), signal strength at each of the two nodes, etc. In general, each wireless connection 65 is characterized by a large set of parameters related to the frequency of transmission, the method of access to a radio resource, etc. One of ordinary skill in the art will recognize that, in general, wireless communication protocols may operate on designated frequencies, such as the ones assigned by the Federal Communications Commission (FCC) in the United States, or in the unlicensed part of the radio spectrum (e.g., 2.4 GHz). While the system and method discussed herein may be applied to a wireless network operating on any designated frequency or range of frequencies, the example embodiment discussed below relates to the wireless network 14 operating in the unlicensed, or shared part of the radio spectrum. In accordance with this embodiment, the wireless network 14 may be easily activated and adjusted to operate in a particular unlicensed frequency range as needed.

With continued reference to FIG. 1, two or more direct wireless connections 65 may form a communication path between nodes that cannot form a direct wireless connection 65. For example, the direct wireless connection 65A between the WirelessHART hand-held device 55 and WirelessHART device 36, along with the direct wireless connection 65B between the WirelessHART device 36 and the router 60, may form a communication path between the devices 55 and 60. As discussed in greater detail below, at least some of the communication paths may be directed communication paths (i.e., permitting or defining data transfer in only one direction between a pair of devices). Meanwhile, the WirelessHART device 36 may directly connect to each of the network devices 55, 60, 32, and to the network access points 25A and 25B. In general, network devices operating in the wireless network 14 may originate data packets, relay data packets sent by other devices, or perform both types of operations. As used herein, the term “end device” refers to a network device that does not relay data packets sent by other devices and term “routing device” refers to a network device that relays data packets traveling between other network devices. Of course, a routing device may also originate its own data or in some cases be an end device. One or several end devices and routing devices, along with several direct connections 65, may thus form a part of a mesh network.

Because a process plant may have hundreds or even thousands of field devices, the wireless network 14 operating in the plant may include a large number of nodes and, in many cases, an even larger number of direct connections 65 between pairs of nodes. As a result, the wireless network 14 may have a complex mesh topology, and some pairs of devices that do not share a direct connection 65 may have to communicate through many intermediate hops to perform communications between these devices. Thus, a data packet may sometimes need to travel along many direct connections 65 after leaving a source device but before reaching a destination device, and each direct connection 65 may add a delay to the overall delivery time of the data packet. Moreover, some of these intermediate devices may be located at an intersection of many communication paths of a mesh network. As such, these devices may be responsible for relaying a large number of packets originated by many different devices, possibly in addition to originating its own data. Consequently, a relatively busy intermediate device may not forward a transient data packet immediately, and instead may queue the packet for a relatively significant amount of time prior to sending the packet to a next node in the corresponding communication path. When the data packet eventually reaches the destination device, the destination device may reply with an acknowledgement packet which may also encounter similar delays. During the time the packet travels to the destination device and the corresponding acknowledgment packet travels back to the originating device from the destination device, the originating node may not know whether the data packet has successfully reached the destination device. Moreover, devices may leave the wireless network 14 due to scheduled maintenance and upgrades or due to unexpected failures, thus changing the topology of the mesh network and destroying some of the communication paths. Similarly, the devices may join the wireless network 14, adding additional direct connections 65. These and other changes to the topology of the wireless network 14 may significantly impact data transmissions between pairs of nodes if not processed in an efficient and timely manner.

Importantly, however, the efficiency of delivering data packets may largely determine the reliability, security, and the overall quality of plant operations. For example, a data packet including measurements indicative of an excessive temperature of a reactor should quickly and reliably reach another node, such as the hand-held device 55 or even the workstation 16, so that the operator or a controller may immediately take the appropriate action and address a dangerous condition if necessary. To efficiently utilize the available direct wireless connections 65 and properly adjust to the frequently changing network topology, the network manager 27 may maintain a complete network map 68, define a routing scheme that connects at least some pairs of network devices 30-50, and communicate the relevant parts of the routing scheme to each network device that participates in the routing scheme.

In particular, the network manager 27 may define a set of directed graphs including one or more unidirectional communication paths, assign a graph identifier to each defined directed graph, and may communicate a relevant part of each graph definition to each corresponding network device, which may then update the device-specific, locally stored connection table 69. As explained in more detail below, the network devices 30-50 may then route data packets based on the graph identifier included in the headers, trailers, etc. of the data packets. If desired, each connection table 69 may only store routing information directly related to the corresponding network device, so that the network device does not know the complete definition of a directed graph which includes the network device. In other words, the network device may not “see” the network beyond its immediate neighbors and, in this sense, the network device may be unaware of the complete topology of the wireless network 14. For example, the router device 60 illustrated in FIG. 1 may store a connection table 69A, which may only specify the routing information related to the neighboring network devices 32, 36, 50, and 34. Meanwhile, the wireless protocol adapter 50A may store a connection table 69B, which accordingly may specify the routing information related to the neighbors of the wireless protocol adapter 50A.

In some cases, the network manager 27 may define duplicate communication paths between pairs of network devices to ensure that a data packet may still reach the destination device along the secondary communication path if one of the direct connections 65 of the primary communication path becomes unavailable. However, some of the direct connections 65 may be shared between the primary and the secondary path of a particular pair of network devices. Moreover, the network manager 27 may, in some cases, communicate the entire communication path to be used to a certain network device, which may then originate a data packet and include the complete path information in the header or the trailer of the data packet. Preferably, network devices use this method of routing for data which does not have stringent latency requirements. As discussed in detail below, this method (referred to herein as “source routing”) may not provide the same degree of reliability and flexibility and, in general, may be characterized by longer delivery delays.

Another one of the core requirements of a wireless network protocol (and particularly of a wireless network operating in an unlicensed frequency band) is the minimally disruptive coexistence with other equipment utilizing the same band. Coexistence generally defines the ability of one system to perform a task in a shared environment in which other systems can similarly perform their tasks while conforming to the same set of rules or to a different (and possibly unknown) set of rules. One requirement of coexistence in a wireless environment is the ability of the protocol to maintain communication while interference is present in the environment. Another requirement is that the protocol should cause as little interference and disruption as possible with respect to other communication systems.

In other words, the problem of coexistence of a wireless system with the surrounding wireless environment has two general aspects. The first aspect of coexistence is the manner in which the system affects other systems. For example, an operator or developer of the particular system may ask what impact the transmitted signal of one transmitter has on other radio system operating in proximity to the particular system. More specifically, the operator may ask whether the transmitter disrupts communication of some other wireless device every time the transmitter turns on or whether the transmitter spends excessive time on the air effectively “hogging” the bandwidth. Ideally, each transmitter should be a “silent neighbor” that no other transmitter notices. While this ideal characteristic is rarely, if ever, attainable, a wireless system that creates a coexistence environment in which other wireless communication systems may operate reasonably well may be called a “good neighbor.” The second aspect of coexistence of a wireless system is the ability of the system to operate reasonably well in the presence of other systems or wireless signal sources. In particular, the robustness of a wireless system may depend on how well the wireless system prevents interference at the receivers, on whether the receivers easily overload due to proximate sources of RF energy, on how well the receivers tolerate an occasional bit loss, and similar factors. In some industries, including the process control industry, there are a number of important potential applications in which the loss of data is frequently not allowable. A wireless system capable of providing reliable communications in a noisy or dynamic radio environment may be called a “tolerant neighbor.”

Effective coexistence (i.e., being a good neighbor and a tolerant neighbor) relies in part on effectively employing three aspects of freedom: time, frequency and distance. Communication can be successful when it occurs 1) at a time when the interference source (or other communication system) is quiet; 2) at a different frequency than the interference signal; or 3) at a location sufficiently removed from the interference source. While a single one of these factors could be used to provide a communication scheme in the shared part of the radio spectrum, a combination of two or all three of these factors can provide a high degree of reliability, security and speed.

Still referring to FIG. 1, the network manager 27 or another application or service running on the network 14 or 12 may define a master network schedule 67 for the wireless communication network 14 in view of the factors discussed above. The master network schedule 67 may specify the allocation of resources such as time segments and radio frequencies to the network devices 25 and 30-55. In particular, the master network schedule 67 may specify when each of the network devices 25 and 30-55 transmits process data, routes data on behalf of other network devices, listens to management data propagated from the network manager 27, and transmits advertisement data for the benefit of devices wishing to join the wireless network 14. To allocate the radio resources in an efficient manner, the network manager 27 may define and update the master network schedule 67 in view of the topology of the wireless network 14. More specifically, the network manager 27 may allocate the available resources to each of the nodes of the wireless network 14 (i.e., wireless devices 30-36, 50, and 60) according to the direct wireless connections 65 identified at each node. In this sense, the network manager 27 may define and maintain the network schedule 67 in view of both the transmission requirements and of the routing possibilities at each node.

The master network schedule 67 may partition the available radio sources into individual communication channels, and further measure transmission and reception opportunities on each channel in such units as Time Division Multiple Access (TDMA) communication timeslots, for example. In particular, the wireless network 14 may operate within a certain frequency band which, in most cases, may be safely associated with several distinct carrier frequencies, so that communications at one frequency may occur at the same time as communications at another frequency within the band. One of ordinary skill in the art will appreciate that carrier frequencies in a typical application (e.g., public radio) are sufficiently spaced apart to prevent interference between the adjacent carrier frequencies. For example, in the 2.4 GHz band, IEEE assigns frequency 2.455 to channel number 21 and frequency 2.460 to channel number 22, thus allowing the spacing of 5 KHz between two adjacent segments of the 2.4 GHz band. The master network schedule 67 may thus associate each communication channel with a distinct carrier frequency, which may be the center frequency in a particular segment of the band.

Meanwhile, as typically used in the industries utilizing TDMA technology, the term “timeslot” refers to a segment of a specific duration into which a larger period of time is divided to provide a controlled method of sharing. For example, a second may be divided into 10 equal 100 millisecond timeslots. Although the master network schedule 67 preferably allocates resources as timeslots of a single fixed duration, it is also possible to vary the duration of the timeslots, provided that each relevant node of the wireless network 14 is properly notified of the change. To continue with the example definition of ten 100-millisecond timeslots, two devices may exchange data every second, with one device transmitting during the first 100 ms period of each second (i.e., the first timeslot), the other device transmitting during the fourth 100 ms period of each second (i.e., the fourth timeslot), and with the remaining timeslots being unoccupied. Thus, a node on the wireless network 14 may identify the scheduled transmission or reception opportunity by the frequency of transmission and the timeslot during which the corresponding device may transmit or receive data.

As part of defining an efficient and reliable network schedule 67, the network manager 27 may logically organize timeslots into cyclically repeating sets, or superframes. As used herein, a superframe may be more precisely understood as a series of equal superframe cycles, each superframe cycle corresponding to a logical grouping of several adjacent time slots forming a contiguous segment of time. The number of time slots in a given superframe defines the length of the superframe and determines how often each time slot repeats. In other words, the length of a superframe, multiplied by the duration of a single timeslot, specifies the duration of a superframe cycle. Additionally, the timeslots within each frame cycle may be sequentially numbered for convenience. To take one specific example, the network manager 27 may fix the duration of a timeslot at 10 milliseconds and may define a superframe of length 100 to generate a one-second frame cycle (i.e., 10 milliseconds multiplied by 100). In a zero-based numbering scheme, this example superframe may include timeslots numbered 0, 1, . . . 99.

As discussed in greater detail below, the network manager 27 reduces latency and otherwise optimizes data transmissions by including multiple concurrent superframes of different sizes in the network schedule 67. Moreover, some or all of the superframes of the network schedule 67 may span multiple channels, or carrier frequencies. Thus, the master network schedule 67 may specify the association between each timeslot of each superframe and one of the available channels.

Thus, the master network schedule 67 may correspond to an aggregation of individual device schedules. For example, a network device, such as the valve positioner 34, may have an individual device schedule 69A. The device schedule 69A may include only the information relevant to the corresponding network device 34. Similarly, the router device 60 may have an individual device schedule 69B. Accordingly, the network device 34 may transmit and receive data according to the device schedule 69A without knowing the schedules of other network devices such as the schedule 69B of the device 60. To this end, the network manager 27 may manage both the overall network schedule 67 and each of the individual device schedules 69 (e.g., 69A and 69B) and communicate the individual device schedules 67 to the corresponding devices when necessary. Of course the device schedules 69A and 67B are subsets of and are derived from the overall or master network schedule 67. In other embodiments, the individual network devices 25 and 35-50 may at least partially define or negotiate the device schedules 69 and report these schedules to the network manager 27. According to this embodiment, the network manager 27 may assemble the network schedule 67 from the received device schedules 69 while checking for resource contention and resolving potential conflicts.

The communication protocol supporting the wireless network 14 generally described above is referred to herein as the WirelessHART protocol 70, and the operation of this protocol is discussed in more detail with respect to FIG. 2. As will be understood, each of the direct wireless connections 65 may transfer data according to the physical and logical requirements of the WirelessHART protocol 70. Meanwhile, the WirelessHART protocol 70 may efficiently support communications within timeslots and on the carrier frequencies associated with the superframes defined by the device-specific schedules 69.

FIG. 2 schematically illustrates the layers of one example embodiment of the WirelessHART protocol 70, approximately aligned with the layers of the well-known ISO/OSI 7-layer model for communications protocols. By way of comparison, FIG. 2 additionally illustrates the layers of the existing “wired” HART protocol 72. It will be appreciated that the WirelessHART protocol 70 need not necessarily have a wired counterpart. However, as will be discussed in detail below, the WirelessHART protocol 70 can significantly improve the convenience of its implementation by sharing one or more upper layers of the protocol stack with an existing protocol. As indicated above, the WirelessHART protocol 70 may provide the same or greater degree of reliability and security as the wired protocol 72 servicing a similar network. At the same time, by eliminating the need to install wires, the WirelessHART protocol 70 may offer several important advantages, such as the reduction of cost associated with installing network devices, for example. It will be also appreciated that although FIG. 2 presents the WirelessHART protocol 70 as a wireless counterpart of the HART protocol 72, this particular correspondence is provided herein by way of example only. In other possible embodiments, one or more layers of the WirelessHART protocol 70 may correspond to other protocols or, as mentioned above, the WirelessHART protocol 70 may not share even the uppermost application layer with any existing protocols.

As illustrated in FIG. 2, the wireless expansion of HART technology may add at least one new physical layer (e.g., the IEEE 802.15.4 radio standard) and two data-link layers (e.g., wired and wireless mesh) to the known wired HART implementation. In general, the WirelessHART protocol 70 may be a secure, wireless mesh networking technology operating in the 2.4 GHz ISM radio band (block 74). In one embodiment, the WirelessHART protocol 70 may utilize IEEE 802.15.4b compatible direct sequence spread spectrum (DSSS) radios with channel hopping on a transaction by transaction basis. This WirelessHART communication may be arbitrated using TDMA to schedule link activity (block 76). As such, all communications are preferably performed within a designated time slot. One or more source and one or more destination devices may be scheduled to communicate in a given slot, and each slot may be dedicated to communication from a single source device, or the source devices may be scheduled to communicate using a CSMA/CA-like shared communication access mode. Source devices may send messages to one or more specific target devices or may broadcast messages to all of the destination devices assigned to a slot.

Because the WirelessHART protocol 70 described herein allows deployment of mesh topologies, a significant network layer 78 may be specified as well. In particular, the network layer 78 may enable establishing direct wireless connections 65 between individual devices and routing data between a particular node of the wireless network 14 (e.g., the device 34) and the wireless gateway 22 via one or more intermediate hops. In some embodiments, pairs of network devices 30-50 may establish communication paths including one or several hops while in other embodiments, all data may travel either upstream to the wireless gateway 22 or downstream from the wireless gateway 22 to a particular node.

To enhance reliability, the WirelessHART protocol 70 may combine TDMA with a method of associating multiple radio frequencies with a single communication resource, e.g., channel hopping. Channel hopping provides frequency diversity which minimizes interference and reduces multi-path fading effects. In particular, the data link 76 may create an association between a single superframe and multiple carrier frequencies which the data link layer 76 cycles through in a controlled and predefined manner. For example, the available frequency band of a particular instance of the wireless network 14 may have carrier frequencies F₁, F₂, . . . Fₙ. A relative frame R of a superframe S may be scheduled to occur at a frequency F₁ in the cycle Cₙ, at a frequency F₅ in the following cycle Cₙ₊₁, at a frequency F₂ in the cycle Cₙ₊₂, and so on. The network manager 27 may configure the relevant network devices with this information so that the network devices communicating in the superframe S may adjust the frequency of transmission or reception according to the current cycle of the superframe S.

The data link layer 76 of the WirelessHART protocol 70 may offer an additional feature of channel blacklisting, which restricts the use of certain channels in the radio band by the network devices. The network manager 27 may blacklist a radio channel in response to detecting excessive interference or other problems on the channel. Further, operators or network administrators may blacklist channels in order to protect a wireless service that uses a fixed portion of the radio band that would otherwise be shared with the wireless network 14. In some embodiments, the WirelessHART protocol 70 controls blacklisting on a superframe basis so that each superframe has a separate blacklist of prohibited channels.

In one embodiment, the network manager 27 is responsible for allocating, assigning, and adjusting time slot resources associated with the data link layer 76. If a single instance of the network manager 27 supports multiple wireless networks 14, the network manager 27 may create an overall schedule for each instance of the wireless network 14. The schedule may be organized into superframes containing time slots numbered relative to the start of the superframe. Additionally, the network manager 27 may maintain a global absolute slot count which may reflect the total of number of time slots scheduled since the start-up of the wireless network 14. This absolute slot count may be used for synchronization purposes.

The WirelessHART protocol 70 may further define links or link objects in order to logically unite scheduling and routing. In particular, a link may be associated with a specific network device, a specific superframe, a relative slot number, one or more link options (transmit, receive, shared), and a link type (normal, advertising, discovery). As illustrated in FIG. 2, the data link layer 76 may be frequency-agile. More specifically, a channel offset may be used to calculate the specific radio frequency used to perform communications. The network manager 27 may define a set of links in view of the communication requirements at each network device. Each network device may then be configured with the defined set of links. The defined set of links may determine when the network device needs to wake up, and whether the network device should transmit, receive, or both transmit/receive upon waking up.

With continued reference to FIG. 2, the transport layer 80 of the WirelessHART protocol 70 allows efficient, best-effort communication and reliable, end-to-end acknowledged communications. As one skilled in the art will recognize, best-effort communications allow devices to send data packets without an end-to-end acknowledgement and no guarantee of data ordering at the destination device. User Datagram Protocol (UDP) is one well-known example of this communication strategy. In the process control industry, this method may be useful for publishing process data. In particular, because devices propagate process data periodically, end-to-end acknowledgements and retries have limited utility, especially considering that new data is generated on a regular basis. In contrast, reliable communications allow devices to send acknowledgement packets. In addition to guaranteeing data delivery, the transport layer 80 may order packets sent between network devices. This approach may be preferable for request/response traffic or when transmitting event notifications. When the reliable mode of the transport layer 80 is used, the communication may become synchronous.

Reliable transactions may be modeled as a master issuing a request packet and one or more slaves replying with a response packet. For example, the master may generate a certain request and can broadcast the request to the entire network. In some embodiments, the network manager 27 may use reliable broadcast to tell each network device in the wireless network 14 to activate a new superframe. Alternatively, a field device such as the sensor 30 may generate a packet and propagate the request to another field device such as to the portable HART communicator 55. As another example, an alarm or event generated by the field device 34 may be transmitted as a request directed to the wireless gateway 22. In response to successfully receiving this request, the wireless gateway 22 may generate a response packet and send the response packet to the device 34, acknowledging receipt of the alarm or event notification.

Referring again to FIG. 2, the session layer 82 may provide session-based communications between network devices. End-to-end communications may be managed on the network layer by sessions. A network device may have more than one session defined for a given peer network device. If desired, almost all network devices may have at least two sessions established with the network manager 27: one for pairwise communication and one for network broadcast communication from the network manager 27. Further, all network devices may have a gateway session key. The sessions may be distinguished by the network device addresses assigned to them. Each network device may keep track of security information (encryption keys, nonce counters) and transport information (reliable transport sequence numbers, retry counters, etc.) for each session in which the device participates.

Finally, both the WirelessHART protocol 70 and the wired HART protocol 72 may support a common HART application layer 84. The application layer of the WirelessHART protocol 70 may additionally include a sub-layer 86 supporting auto-segmented transfer of large data sets. By sharing the application layer 84, the protocols 70 and 72 allow for a common encapsulation of HART commands and data and eliminate the need for protocol translation in the uppermost layer of the protocol stack.

FIGS. 3 and 4 illustrate some of the advantages of a wireless HART approach to building or extending process control networks. In particular, FIG. 3 contrasts a legacy approach to reporting process variables schematically represented in configuration 100 to a wired HART approach represented in a configuration 102. FIG. 4 further illustrates some of the additional advantages of an approach using a wireless extension of HART.

Referring to FIG. 3, a hardwired 4-20 mA instrument 102, which may be a Coriolis flowmeter, can only report a single process variable to a Distributed Control System (DCS) 104 via a wired connection 106 which typically passes through a marshalling cabinet 108. For example, the instrument 102 may report a flow rate measurement to the DCS 104. With the introduction of the HART standard, it became possible to report multiple variables over a single pair of electrical wires and, moreover, the introduction of a HART multiplexer 110 provided support for 4-20 mA devices. In particular, each of several inputs of the HART multiplexer 110 may be used for a separate hardwired connection 112 to a separate loop for measuring flow rate, density, temperature, etc. The HART multiplexer 110 may then report these multiple variables to the DCS 104 via a wired connection 114. However, while an input module or a multiplexing device such as the HART multiplexer 110 may allow the DCS 104 to communicate with several legacy field devices using a single connection 112, retrofitting such legacy equipment may be difficult, expensive, and time consuming. To take one example, the use of the HART multiplexer 110 still requires re-wiring of the marshalling cabinet 108 and adding a hardwired connection 112 for each loop.

On the other hand, FIG. 4 illustrates a more advantageous configuration 120 which may rely on the wireless HART protocol 70. As briefly indicated above, a wireless protocol adapter 50 may work in cooperation with an existing instrument (e.g., positioner, transmitter, etc.) to support the 4-20 mA signaling standard while providing access to the set of process variables consistent with the HART standard. Thus, the configuration 120 may be updated to the configuration 120 while leaving the marshalling cabinet 108 intact. More specifically, the wireless HART adapter 50 may connect to the field device 102 in a wired manner and establish a wireless connection with a gateway 122, which may also communicate with one or more wireless HART devices 124. Thus, wireless HART field devices, adapters, and gateways may allow plant operators to upgrade an existing network in a cost-effective manner (i.e., add a wireless HART adapter to a legacy device) as well as extend an existing network by using wireless HART devices such as the device 124 in the same network as wired HART devices (not shown) and legacy devices such as 4-20 mA equipment. Of course, wired plant automation networks may also include devices using other protocols such as Foundation Fieldbus, Profibus DP, etc., and it will be noted that the components 50 and 122 may similarly extend and upgrade other networks. For the sake of clarity, all such networks are referred to herein as “legacy networks.”

It will be also noted that instruments with built-in wireless HART capability provide the additional advantage that these devices could be self-powered (e.g., battery-powered, solar powered, etc.). Among other advantages of the wireless approach are the ability to add multivariable data access to individual instruments as required, the elimination of the need to re-wire marshalling cabinets to accommodate HART multiplexers, and the possibility of maintaining primary measurements on a 4-20 mA signaling line while accessing secondary process measurements via the wireless protocol adapter 50. Further, a host such as the workstation 16 (see FIG. 1) may use standard HART commands to read the necessary process values (universal commands) from a network device wirelessly coupled to the wireless network 14. Still further, a user can access all the device functions available via the HART commands, including for example, diagnostic messages, or remotely upload and download device configuration.

To further illustrate some of the advantages of the wireless approach discussed herein and, in particular, of using a wireless protocol adapter 50 to connect legacy or smart field devices to a wireless mesh network (e.g., the wireless network 14), another prior art configuration 200 is shown in FIG. 5. In this example, a remote I/O system 202 may be connected to a workstation 204 via a link 206 which may be an RS-485 connection, for example. The remote I/O system may support HART communications between the workstation 204 and each of the HART field devices 210-216 over Frequency-Shift Keying (FSK) or Phase-Shift Keying (PSK), for example, thereby eliminating the need to separately wire each HART field devices 210-216 directly to the workstation 204.

Now referring generally to FIGS. 1 and 6-7, the wireless protocol adapter 50 may include at least the functionality of the remote I/O system 202. In particular, as illustrated in FIG. 6, the wireless protocol adapter 50 may include a wireless interface 250 for communicating with a wireless mesh network 252 and a wired interface 260 to exchange data with at least one wired field device 262 via a wired link 264. The wired field device 262 may be a wired HART device having a five-byte HART address and the wireless mesh network 252 may be a wireless HART network supporting a compatible addressing scheme. As discussed above with reference to FIG. 2, the wireless HART protocol 70 and the wired HART protocol 72 may share at least the application layer 84, allowing the wireless protocol adapter 50 to seamlessly transfer commands to and from the wired field device 262 by providing protocol translation at the lower layers of the corresponding protocol stacks.

In this embodiment, the wireless protocol adapter 50 may also have a unique HART address so that network devices operating in the wireless network 252 may separately address the wireless protocol adapter 50 and the wired field device 262. In this sense, the wireless protocol adapter 50 may be a network node responsible for routing data between other devices.

In another embodiment, the wired field device 262 may be a legacy 4-20 mA device. The wireless protocol adapter 50 may accordingly translate wireless HART commands to 4-20 mA analog signals and, conversely, digitize the output of the legacy wired field device 262 and transmit the converted output as digital data to the wireless network 252. It will be appreciated that these approaches may provide several important advantages such as adding multivariable data access to individual instruments (e.g., by supporting HART with legacy 4-20 mA devices) or allowing primary measurements to continue via a 4-20 mA signal while accessing secondary process measurements. Specifically with respect to the latter approach, the wireless protocol adapter 50 may be coupled to a 4-20 mA loop without dismantling the original connections and, possibly by scavenging power in the loop, the wireless protocol adapter 50 may function as a HART modem to secondary process data and transmit this data to the wireless network 252. Meanwhile, the legacy wired field device 262 may continue to operate within the original 4-20 mA loop by exchanging a certain type of control and/or process data with a control system such as a PLC or a DCS, for example.

Further, it will be noted that an external host (not shown) connected to the wireless network 252 may use standard HART commands to read the process values by means of universal (i.e., universally supported) commands. Still further, in addition to reading process variables from the wired field device 262, a user operating the external host may access the device functions of the wired field device 262 accessible via HART commands such as the diagnostic messages, for example. Similarly, the user may remotely download a new configuration into the wired field device 262.

In another embodiment, by using a wireless protocol adapter 250, the wired field device 262 may tunnel PROFIBUS messages to the external host. In this case, the wired link 264 may support be a digital bus supporting PROFIBUS communications and the wired interface 260 may accordingly interpret and encode PROFIBUS commands, addressing, etc.

FIG. 7 illustrates a multi-drop configuration in which the wireless protocol adapter 250 supports multiple wired field devices 262 and 270. In this embodiment, the wireless protocol adapter 250 may additionally operate as a multiplexer. Each of the wired field devices 262 and 270 may have a unique identifier such as a HART address or an address on the digital bus (e.g., the wired link 264). A wired handheld device 272 may also connect to the wired link 264 to communicate with the wired field devices 262 and 270 and, in some embodiments, with the wireless network 252. In one particular embodiment, the handheld device 272 may connect to the wireless HART devices in the wireless network 252 through an FSK modem. By contrast, a wireless handheld device 55 may connect to the network devices 32 or 36, for example, only via the wireless gateway 22 (see FIG. 1).

To enable discovery of the one or more wired field devices on an analog or digital wired link 264, the wireless protocol adapter 250 may support commands used for discovering sub-devices on a remote I/O system. In other words, a remote host may be able to access the wireless protocol adapter 250 via the wireless network 252, request a discovery of sub-devices such as the wired field devices 262 and 270, receive a list of the devices connected to the wired interface 260 as well as the addresses of these devices, and consequently communicate with the wired field devices 262 and 270 via the wireless protocol adapter 250. In particular, the remote host may request a block mode transfer to receive the results of a vibration analysis, for example, or access other process data stored by the wired field devices 262 or 270. Of course, the wireless protocol adapter 250 may also allow the wired field devices 262 and 270 to regularly publish process data within the assigned timeslots as part of burst mode communications. In addition, if the wired field device 262 or 270 does not support burst mode, the wireless protocol adapter 250 may perform this function on behalf of the wired field device 262 or 270. More specifically, the wireless protocol adapter 250 may poll the wired field device 262 or 270 to obtain the relevant information and publish the collected information in accordance with the communication scheme supported by the wireless network 14. The wireless protocol adapter 250 may also perform a multi-step procedure, execute a sequence of legacy commands, or collect a series of measurements using an analog signaling scheme supported by the wired field device 262 or 270, etc. to prepare a report for publishing on the wireless network 14. In this manner, the wireless protocol adapter 250 may not only provide wireless functionality to a wired field device 262 or 270 but also extend the general capability of the wired field device 262 and 270.

In another aspect, the wireless protocol adapter 250 may also support alarm and event reporting on behalf of the wired field device 262 or 270. For example, the wireless protocol adapter 250 may periodically query the wired field device 262 or 270 to collect event data. Further, as indicated above, the wireless protocol adapter 250 may similarly provide block mode transfer between the wired field device 262 or 270 and the wireless network 14 even if the wired field device 262 or 270 does not support block mode transfer. Generally with respect to supporting burst mode, block mode transfer, alarm and event data, etc., it will be noted that the wireless protocol adapter 250 may properly associate the type of data with one of several priority levels supported by the wireless network 14 even if the wired field device 262 or 270 does not prioritize or otherwise classify data. This and similar functionality may be generally referred to as an extension function provided to the wired field device 262 or 270 by the wireless protocol adapter 250.

In yet another aspect, the wired field device 262 or 270 may be a smart field device supporting an older version of the protocol whose wireless extension the wireless protocol adapter 250 supports at the wireless interface. In particular, the wired field device 262 or 270 may support an older version of HART while the wireless protocol adapter 250 may support a newer version of HART including additional commands and/or functions. In this case, the wireless protocol adapter 250 may provide the functionality of the newer HART standard to the older HART device such as the wired field device 262 or 270 by implementing a corresponding procedure on the wired interface.

Additionally, it is contemplated that the wireless protocol adapter 250 may include one or more delayed response buffers for queuing commands if one of the wired link 264 or the wireless mesh network 252 has a slower response time. The wireless protocol adapter 250 may use the Delayer Response Mechanism (DRM) to indicate to the device communicating over the faster network that a command or data has been received and is being processed.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

What is claimed:

1. A wireless protocol adapter for use in a process system, comprising:
a wireless interface that communicates with a multi-node wireless communication network using a wireless communication protocol;
a wired interface that connects to a first field device over a wired link; and
a processing unit that transfers process data between the wireless communication network and the first field device to enable operation of the first field device and of the wireless protocol adapter in the wireless communication network as distinct network nodes.

2. The wireless protocol adapter of claim 1, wherein the wired interface supports 4-20 mA analog signaling; and wherein the multi-node wireless communication network operates using a wireless extension of the HART® communication protocol.

3. The wireless protocol adapter of claim 1, wherein the wired interface supports HART® communication protocol; and wherein the multi-node wireless communication network operates using a wireless extension of the HART® communication protocol sharing at least an application layer with the HART® communication protocol.

4. The wireless protocol adapter of claim 1, wherein the wired interface supports at least one of HART®, PROFIBUS, FOUNDATION FIELDBUS, or DeviceNet standards.

5. The wireless protocol adapter of claim 1, wherein the wireless interface and the wired interface support respective protocols sharing at least an application layer; and wherein the processing unit transfers process control data between the wireless communication network and the first field device by separating application layer data from at least a physical layer of a respective protocol.

6. The wireless protocol adapter of claim 1, further comprising:
a memory that stores an address of the wireless protocol adapter; wherein the address adapter conforms to an addressing scheme of the wireless communication network; and
wherein the wired interface supports the addressing scheme of the wireless communication network.

7. The wireless protocol adapter of claim 6, further wherein the memory further stores an adapter device descriptor (DD) conforming to the Device Description Language (DDL) and an adapter manufacturer identity; and wherein the first field device is associated with a DD confirming to DDL and distinct from the adapter DD.

8. The wireless protocol adapter of claim 1, wherein the wired interface further connects to a second field device over the wired link.

9. The wireless protocol adapter of claim 8, wherein the processing unit further includes a router for routing data between each of the first field device, the second field device, and the wireless communication network.

10. The wireless protocol adapter of claim 8, wherein the wired interface further connects to a portable unit; and wherein the processing unit provides the portable unit with access to the wireless communication network for at least one of maintenance or diagnostics.

11. The wireless protocol adapter of claim 1, wherein the wired interface connects to the first field device without disturbing an operation of the original circuit in which the first field device is connected.

12. A method of providing a wireless capability to a first field device supporting a communication standard and operating in a process control loop, comprising:
communicating with the first field device via a wired interface in accordance with the communication standard while the process control loop is operational;
communicating with a wireless communication network via a wireless interface; and
transferring data between the wired interface and the wireless interface to enable the first field device to operate in the wireless communication network.

13. The method of claim 12, wherein communicating with the first field device includes addressing the first field device according to an addressing scheme associated with the communication standard, wherein the addressing scheme is consistent with an addressing scheme of the wireless communication network.

14. The method of claim 13, wherein the addressing scheme is associated with the HART® communication protocol.

15. The method of claim 12, further comprising:
communicating with a second field device operating in the process control loop via the wired interface; and
supporting a multi-drop connection between the wireless communication network and each of the first field device and the second field device.

16. The method of claim 12, wherein communicating with the first field device via a wired interface includes using an analog signaling scheme; wherein communicating with a wireless communication network includes supporting a digital communication protocol; and wherein transferring data between the wired interface and the wireless interface includes performing an analog-to-digital conversion in a direction of the wireless interface and a digital-to-analog conversion in a direction of the wired interface.

17. A multi-element electrical circuit operating a process control environment, comprising:
a first field device that performs at least one of a process control function or a measurement function;
a control system that exchanges data related to the at least one of a process control function or a measurement function with the first field device;
an electrical connector communicatively coupling the first field device with the control system; and
a wireless protocol adapter coupled to the first field device to provide wireless communications between the first field device and a wireless communication network.

18. The multi-element electrical circuit of claim 17, wherein the control system is a PLC.

19. The multi-element electrical circuit of claim 17, wherein the control system is a DCS.

20. The multi-element electrical circuit of claim 17, wherein the electrical connector supports communications related to at most one process control function or a measurement function; and wherein the wireless protocol adapter receives data from the first field device unrelated to the one of a process control function or a measurement function.

21. The multi-element electrical circuit of claim 17, further comprising a second field device; and wherein wireless protocol adapter is coupled to the first field device and to the second field device to provide routing between each of the first field device and the second field device and the wireless communication network.

22. A method of extending a capability of a wired field device operating in a process control environment with a wireless protocol adapter, comprising:
connecting the wired field device to a wired interface of the wireless protocol adapter;
communicating between the wireless protocol adapter and the wired field device in accordance with a wired communication standard supported by the wired field device to perform an extension function associated with a wireless communication protocol, wherein the extension function is not associated with the wired communication standard; and
communicating between wireless protocol adapter and a wireless communication network via a wireless interface supporting the wireless communication protocol.

23. The method of claim 22, wherein communicating between wireless protocol adapter and a wireless communication network includes reporting a result of executing the extension function.

24. The method of claim 22, wherein the wireless communication protocol supports a command set of the HART® communication protocol; wherein the wired field device is a 4-20 mA device; and wherein the wired communication standard is associated with analog signaling over a wire pair.

25. The method of claim 22, wherein the wireless communication protocol supports a first command set of the HART® communication protocol; wherein the wired field device is a wired HART® device supporting a second command set associated with an older version of the HART® communication protocol than the version corresponding to the first command set; and wherein the extension function is associated with the first command set but not with the second command set.

26. The method of claim 22, wherein communicating between the wireless protocol adapter and the wired field device to perform an extension function includes obtaining information indicative of a condition of the wired field device to report one of an alarm or an event associated with the wireless communication protocol.

27. The method of claim 22, wherein communicating between the wireless protocol adapter and the wired field device to perform an extension function includes polling for device data to support burst mode communications associated with the wireless communication protocol.

28. The method of claim 22, wherein communicating between the wireless protocol adapter and the wired field device to perform an extension function includes:
receiving a request for a block mode transfer from the wireless communication network via the wireless interface;
retrieving device data according to the wired communication standard;
buffering the device data at the wireless protocol adapter; and
transferring the device data to the wireless communication network via the wireless network.

29. The method of claim 28, wherein the device data is a measurement procedure performed at the wired field device.
